(19) United States
(12) Patent Application Publication
(10) Pub. No.: US 2016/0186825 A1
(43) Pub. Date: Jun. 30, 2016

(54) COMBINED VEHICLE BRAKE WITH A BALL SCREW DRIVE

(71) Applicant: CONTINENTAL TEVES AG & CO. OHG, Frankfurt (DE)

(72) Inventors: Thomas Winkler, Mainz (DE); Dieter Füller, Nauheim (DE); Thomas Hess, Seeheim-Jugenheim (DE); Patrick Walter, Offenbach am Main (DE); Jürgen Bauer, Wiesbaden (DE); Jürgen Völkel, Frankfurt am Main (DE)

(21) Appl. No.: 14/907,414

(22) PCT Filed: Aug. 4, 2014
(86) PCT No.: PCT/EP2014/066736

§ 371 Date: Jan. 25, 2016

(30) Foreign Application Priority Data
Aug. 16, 2013 (DE) 10 2013 216 327.4

(51) Int. Cl. F16D 65/18

(52) U.S. Cl. CPC F16D 65/18; F16D 2121/02

(57) ABSTRACT

A combined vehicle brake which has a hydraulically actuable service brake and an electromechanically actuable parking brake device. The present invention is based on the problem of improving the known ball screw drives for use in vehicle brakes, of making simple automated assembly possible, and in addition of opening up the possibility to increase cycle times. A spring element of double helical type which is configured differently in sections is provided, in a middle section, that is to say in the drive thread turn, which substantially do not impede the elastically pliable adaption of the spring element to the helically wound drive thread turn, and wherein a bearing section is additionally provided at at least one end of the spring element, which bearing section has an increased transverse rigidity or has it impressed onto it in comparison with the middle section.

### CROSS REFERENCE TO RELATED APPLICATIONS

This application is the U.S. National Phase Application of PCT International Application No. PCT/EP2014/066736, filed Aug. 4, 2014, which claims priority to German Patent Application No. 10 2013 216 327.4, filed Aug. 16, 2013, the contents of such application being incorporated by reference herein.

### FIELD OF THE INVENTION

The present invention concerns a combined vehicle brake with a ball screw drive comprising a hydraulically operated operating brake and an electromechanically operated parking brake, wherein a hydraulic operating pressure chamber in a brake housing is bounded by a brake piston that is acted upon by a hydraulic pressure medium to perform operating braking, so that the brake piston can be actuated along a piston longitudinal axis to achieve a braking effect, and wherein the parking brake device acts upon the brake piston by means of a gearbox by the gearbox converting the rotational movement of an electromechanical actuator into a translational movement and causes the operation of the brake piston to perform parking brake processes and maintains the operated position, wherein the gearbox comprises a threaded spindle and a threaded nut that are in contact with each other by means of a plurality of roller bodies, wherein a coil spring element is provided that enables sliding of the roller bodies in the event of no-load operation of the gearbox and causes rolling of the roller bodies in the event of operation of the gearbox under load.

### BACKGROUND OF THE INVENTION

Such a hydraulic vehicle brake with an electrically operated parking brake device is known from DE 10 2009 019 793 A1 whis is incorporated herein by reference and comprises a roller body screw drive with a spindle, a nut and with roller bodies (balls), which are disposed so as to carry out limited movement in the thread between two stops, wherein a coil spring element is disposed between the respective roller body at the end and a stop to provide a roller path for the roller bodies 4. The stop is in the form of pouch-shaped recesses and extends tangentially starting from the thread of the threaded nut. The pouch-shaped recess ends in a perpendicular stop surface on which the coil spring element is supported, as illustrated in particular in FIG. 2. The assembly of a substantially miniaturized ball screw drive from many components, including roller bodies and coil springs in a curved thread between a spindle and a nut is not trivial.

### SUMMARY OF THE INVENTION

An aspect of the present invention is to improve both the operating function and also the process reliability during the assembly of a generic multi-part ball screw drive, to enable simple automated assembly and at the same time to open up the possibility of increasing cycle times.

An aspect of the present invention is achieved in principle with a spring element of the double helix type with segments of different design, in which in a central segment, i.e. in the gearbox thread, means are provided that do not significantly hinder the elastically yielding adaptation of the coil spring to the helically wound thread, and wherein in addition a contact segment is provided on at least one end of the coil spring that has greater lateral rigidity compared to the central segment or to which greater lateral rigidity is imparted.

A preferred aspect of the invention consists of the contact segment comprising windings having at least two coil spring pitches p1 and p2 of different forms. In particular, a plurality of coil spring windings can be wound with reduced pitch, especially in a block, i.e. without any or at least with a small distance between them, whereas coil spring windings connecting thereto comprise an increased pitch. Owing to said measures, a supporting effect is achieved. A favorable effect is also achieved if a final turn of a winding is ground off so that central force introduction and support are enabled. It is further possible that instead of a chamfer on the spring element, an inclined contact surface is provided, which can be achieved for example by deformation, stamping or similar. Furthermore, the spring element can preferably be malleably pre-stamped, thus it can be of the double helix form.

### BRIEF DESCRIPTION OF THE DRAWINGS

The invention is described in detail below using an exemplary embodiment in combination with the accompanying figures. In the figures:

FIGS. 1+2 show sectional representations of a vehicle brake with a hydraulically actuated operating brake and an electromechanically actuated parking brake as well as an associated threaded nut according to DE 10 2009 019 793 A1;

FIG. 3-6 show embodiments according to aspects of the invention for a new coil spring/nut arrangement and wherein the spring element comprises different segments, and

FIG. 7 shows an installation situation for a coil spring according to an aspect of the invention.

### DETAILED DESCRIPTION OF THE PREFERRED EMBODIMENTS

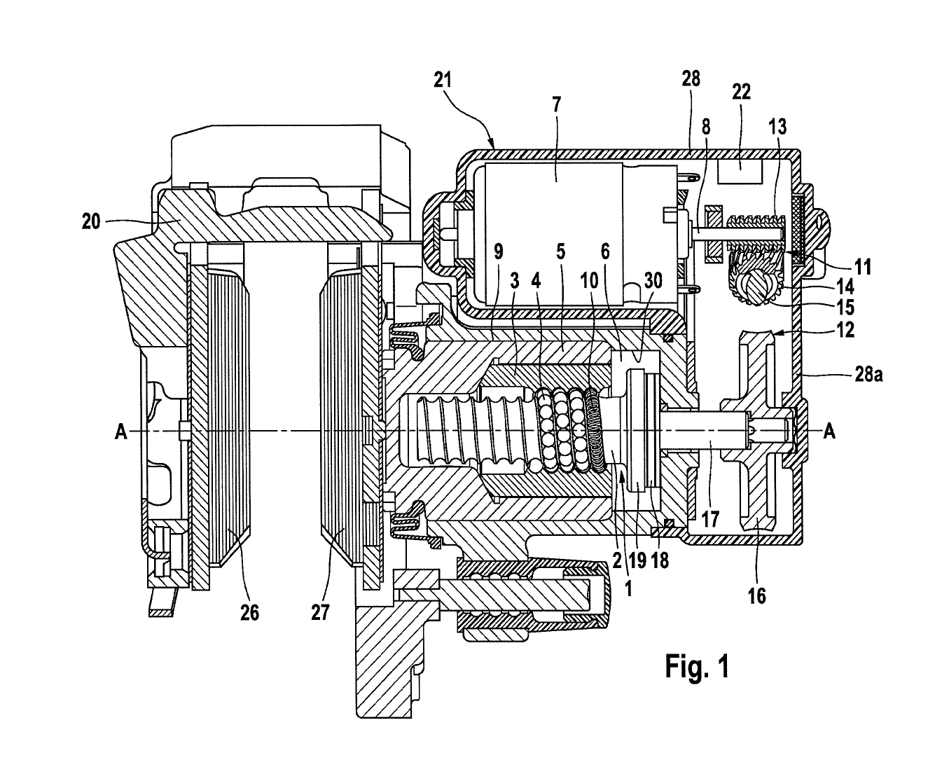

The hydraulic vehicle brake represented in FIG. 1 comprises on the one hand a hydraulically actuated operating brake and on the other hand an electromechanically actuated parking brake. The vehicle brake is implemented in the example shown as a floating caliper disk brake, the operation of which that is caused by hydraulic actuation is well known to persons skilled in the art in this field, and therefore does not require a detailed description here. An electromechanical actuator 7 or electric motor 7 is used to operate the parking brake, being integrated within a drive module 21 together with a two-stage gearbox, the necessary sensors as well as an electronic control unit 22. Furthermore, the aforementioned vehicle brake comprises a brake housing or a brake caliper 20 that encloses the outer edge of a brake disk (not shown) and two brake linings 26, 27 that are disposed on both sides of the brake disk. The brake housing 20 forms a brake cylinder 9 on its inside that accommodates a brake piston 5 that can be displaced axially. Brake fluid can be delivered into the operating pressure chamber 6 that is formed between the brake cylinder 9 and the brake piston 5 so as to perform operating braking, so that a brake pressure is built up that displaces the brake piston 5 axially along a piston longitudinal axis A towards the brake disk. As a result, the brake lining 27 facing towards the brake piston 5 is pressed against the brake disk, wherein as a reaction the brake housing 20 is displaced in the opposite direction and thereby also presses the other brake lining 26 against the brake disk.

As has already been mentioned, a parking brake device for performing parking brake processes can be operated electromechanically and also acts on the brake piston 5. A gearbox 1 is provided for this that converts the rotational movement of the electromechanical actuator 7 or electric motor 7 into a translational movement and causes the operation of the brake piston 5 along the axis A. The gearbox 1 is essentially formed by a threaded spindle 2 and a threaded nut 3, which are connected to each other by means of roller bodies 4. The roller bodies 4 are in the form of balls. A shaft 17 connected to the threaded spindle 2 protrudes from the brake housing 20 on the side facing away from the brake disk and is driven by the aforementioned electromechanical actuator 7 with the interposition of a two-stage reduction gearbox. In this case a means for sealing the operating pressure chamber 6 is provided in the bore of the brake housing 20 through which the shaft 17 protrudes. The rotational movement transferred to the threaded spindle 2 is transferred to the threaded nut 3 by means of the balls 4 located in the thread between the threaded spindle 2 and the threaded nut 3, which performs a translational movement in the direction of the axis A. As a result, the brake piston 5, on which the threaded nut 3 is supported, is also operated. At the same time, the threaded spindle 2 is accommodated by a stepped bore 30 in the brake housing 20 and is supported on the brake housing 20 by means of a collar 19, which is connected to the spindle 2, and an axial bearing 18. The gearbox 1 thus converts the rotary displacement of the electromechanical actuator 7 into a linear movement and is responsible for the generation of the clamping force for performing a parking brake process.

When releasing the parking brake device, the electric motor is accordingly operated in the opposite direction and the threaded nut 3 and hence also the brake piston 5 perform a movement to the right in the figure. The brake linings 26, 27 are no longer in contact with the brake disk and the parking brake process is terminated.

The aforementioned electric motor 7 and the two-stage gearbox are accommodated by a housing 28 forming part of the drive module 21, which can be closed by a housing cover 28a. In the embodiment represented in FIG. 1, the two-stage gearbox is in the form of a worm gear 11, 12. Worm gears are a category of helical roller gearboxes, in which there is also a sliding component of the movement in contrast to roller gearboxes. Such a worm gear is made up of a helical toothed wheel, i.e. a worm, and an inclined tooth wheel that engages therewith, i.e. the worm wheel.

The first stage of the gearbox, i.e. the first worm gear 11, is connected on the input side to the output shaft 8 of the electric motor 7, whereas the second stage of the gearbox, i.e. the second worm gear 12, is connected on the output side to the shaft 17 or to the gearbox 1 or 2, 3. As is shown, a first worm 13 is fitted onto the output shaft 8 of the electric motor 7 and engages a first worm wheel 14. A second worm 15 is fitted into the center of rotation of the first worm wheel 14 and is set in rotation by the same. The second worm 15 in turn engages a second worm wheel 16, which is rotationally fixedly connected to the shaft 17 and sets the shaft 17 together with the gearbox 1 in rotation and in doing so produces a translational motion of the brake piston 5. Hence the clamping force that is set in this way is maintained during a parking brake process if the second worm gear 12 is implemented so as to be self-locking.

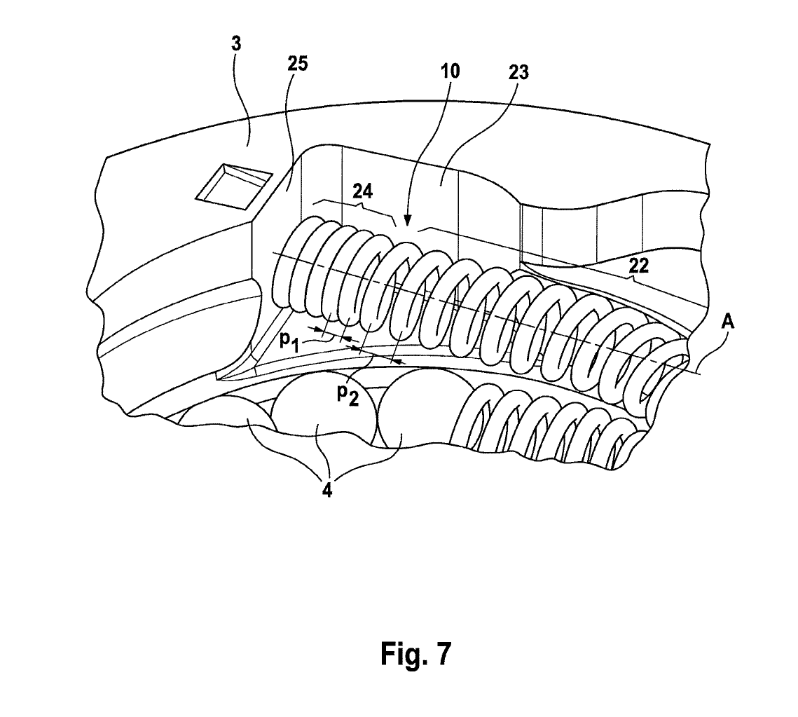

In the event of operation of the gearbox 1 under load, the roller bodies 4 roll in the thread. As a result, a relatively high efficiency of 85% to 95% is achieved, or 75% to 85% taking into account the frictional losses at the axial bearing 18. In the event of a no-load operation of the gearbox 1, the roller bodies 4 slide by comparison, i.e. the balls 4 slide until the brake lining 27 associated with the brake piston 5 contacts the brake disk (not shown) because in this case it is almost a no-load operation. Only under load do the balls 4 start to roll. The gearbox 1 thus acts simultaneously as a means of readjustment if the brake linings 26, 27 are worn. The omission of a separate readjustment device or the integration of the readjustment device and the operating device within a single component is particularly cost-effective and at the same time robust. Hence the rolling of the roller bodies 4 under load and the sliding during no-load operation of the gearbox 1 is always possible if a coil spring element 10 is provided that provides a rolling path for rolling of the roller bodies 4. The roller bodies 4 are disposed to be able to move in the thread to a limited extent between two stops, wherein the coil spring element 10 for providing a roller path for the roller bodies 4 is disposed between the roller bodies 4 and a first stop. The first stop is in the form of pouch-shaped recesses 23 and extends tangentially starting from the thread of the threaded nut 3. The pouch-shaped recess 23 ends in a perpendicular stop surface 25 on which the coil spring element is supported, as is particularly illustrated in FIG. 2. A second coil spring element (see FIG. 7) is disposed between the roller bodies 4 and another stop, i.e. another pouch-shaped recess, and is used as the so-called input pressure coil spring. Said input pressure coil spring is supported in the second pouch-shaped recess.

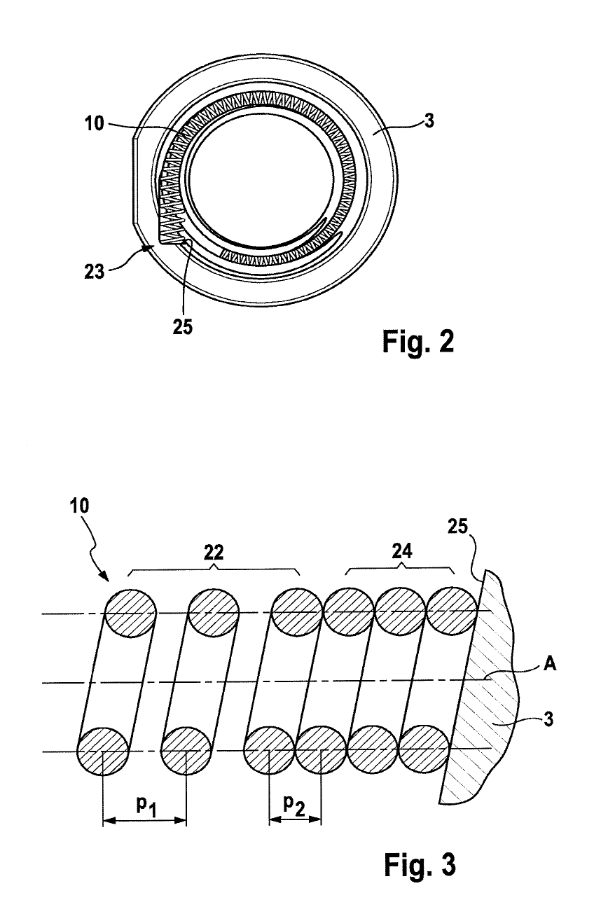

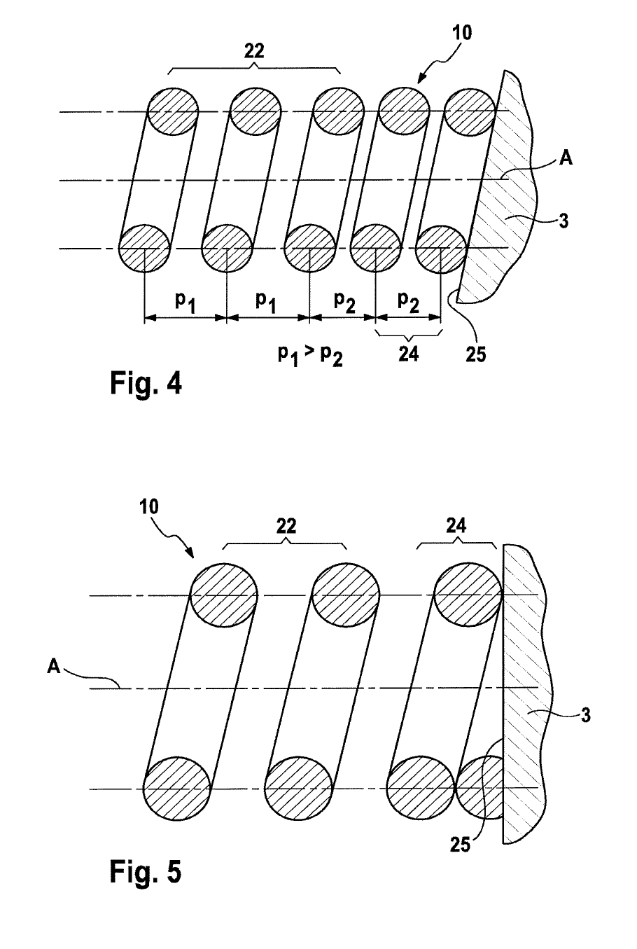

Features, special features and components of a new roller body drive system with a double wound spring element 10 are described in detail below using FIGS. 3-7. With this said features of all embodiments can be provided individually or even in any combination with each other in a product without departing from the basic ideas of the invention.

According to FIGS. 3-7, the coil spring element of the double helix type that has differently shaped segments comprises a central segment 22 and a contact segment 24. Means are provided in the gearbox thread that do not significantly hinder the elastically yielding adaptation of the coil spring to the helically wound thread, and wherein in addition the means are provided on at least one end (contact segment 24) of the coil spring element 10 that have greater lateral rigidity in relation to the spring axis A compared to the central segment 22, or to which the increased lateral rigidity is imparted.

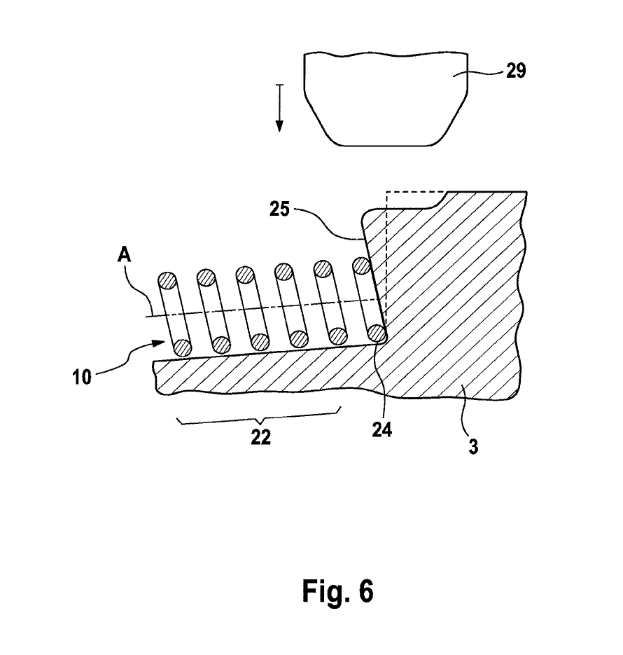

A preferred version of the invention consists of a double wound coil spring, wherein the coil spring contact segment 24 comprises windings that are provided with at least two coil spring pitches p1 and p2 of different forms. In particular, a plurality of coil spring windings of the coil spring contact segment 24 can be wound with reduced pitch p2, in particular in a block, i.e. with no or at least with a small distance from each other, whereas the coil spring windings connecting thereto comprise an increased pitch p1. Owing to said measures, a reduction of the lateral rigidity is achieved in the thread of the ball screw drive for good adaptation of the spring to the course of the thread. In contrast, the contact segment 24 of the spring comprises increased lateral rigidity or is deliberately deflected in an advantageous direction. The installation situation can be seen from FIG. 7. As a result, the contact segment 24 jumping out of the recess 23 in the threaded nut 3 can be prevented. A particularly advantageous, central introduction of force into the spring element 10 is achieved if a final winding of the spring element 10 is ground off so that the same is seated smoothly on its stop surface 25 on the nut side. Alternatively or additionally-in combination, it is also possible to associate a deliberately inclined stop surface 25 with the final coil spring winding on the nut side, which can be achieved for example by reshaping without cutting by means of a tool punch 29 (see FIG. 6) or by machining the stop surface 25. The inclination of said stop surface 25 can also be deliberately disposed at an inclination in space such that axis A of the coil spring is deflected in an advantageous direction. In other words, it is conceivable to design the force introduction to the contact segment 24 such that the spring element 10 in particular contacts adjacent components (for example the thread of a threaded spindle 2 or a threaded nut 3). Furthermore, besides its own single helix, in addition the helical shape of the ball screw drive can be superimposed on the spring element 10 in a malleably overlaid manner. As a result, unwanted friction between the gearbox thread and the spring element 10 can be prevented or reduced.

1. A combined vehicle brake with a ball screw drive, comprising a hydraulically actuated operating brake and an electromechanically actuated parking brake device, wherein a hydraulic operating pressure chamber in a brake housing is bounded by a brake piston that is acted upon by a hydraulic pressure medium for performing operating braking so that the brake piston can be actuated along a piston longitudinal axis to achieve a braking effect, and wherein the parking brake device acts on the brake piston by a gearbox, the gearbox converting a rotational movement of an electromechanical actuator into a translational movement and causes operation of the brake piston for performing parking brake processes and holds it in the operated position, wherein the gearbox comprises a threaded spindle and a threaded nut that are in contact with each other by a plurality of roller bodies, wherein a spring element is provided that enables sliding of the roller bodies in the event of a no-load operation of the gearbox and causes rolling of the roller bodies in the event of the operation of the gearbox under load, a spring element of the double helix type with segments of different forms is provided, such that in a central segment in the gearbox thread, means are provided that do not significantly hinder an elastically yielding adaptation of the spring element to the helically wound gearbox thread, and wherein a contact segment is provided on at least one end of the spring element that has increased lateral rigidity compared to the central segment, or has increased lateral rigidity imparted thereto.

2. The combined vehicle brake as claimed in claim 1, wherein the contact segment comprises coil spring windings having at least two mutually differently formed adjacent coil spring pitches p1, p2.

3. The combined vehicle brake as claimed in claim 2, wherein a plurality of coil spring windings with reduced coil spring pitch p2 is wound, in a block, with no or at least with little distance between them, whereas coil spring windings connecting thereto comprise an increased coil spring pitch p1.

4. The combined vehicle brake as claimed in claim 1 wherein a final winding on the contact segment is ground off at right angles to a central spring axis A so that central force introduction and support on a stop surface are enabled.

5. The combined vehicle brake as claimed in claim 1, further comprising a stop surface that is inclined at an oblique angle in relation to a central spring axis A.

6. The combined vehicle brake as claimed in claim 1, wherein the spring element comprises a malleably shaped double helix.

7. The combined vehicle brake as claimed in claim 1, wherein a pitch of the gearbox thread is of a different form compared to the pitch p1 of the coil spring.
